(19) United States
(12) Patent Application Publication
(10) Pub. No.: US 2005/0169353 A1
(43) Pub. Date: Aug. 4, 2005

(54) Post despreading interpolation in CDMA systems

(76) Inventors: Wei An, Waltham, MA (US); Stephen J. Plante, Stoughton, MA (US)

Correspondence Address: William R. McClellan;Wolf, Greenfield & Sacks, P.C., 600 Atlantic Avenue, Boston, MA, 02210, US

(21) Appl. No.: 10/769,996

(22) Filed: Feb. 2, 2004

(51) Int. Cl. H04B 1/707

(52) U.S. Cl. 375/147

(57) ABSTRACT

Methods and apparatus for processing a spread spectrum baseband signal, such as a CDMA baseband signal, are provided. The method includes despreading samples of the baseband signals with two or more instances of a despreading code, the instances of the spreading code successively offset relative to the signal samples, to provide two or more despread results, and interpolating the two or more despread results based on an estimated finger location to provide a symbol estimate. The method provides post-despreading interpolation.

### FIELD OF THE INVENTION

This invention relates to wireless communications and, more particularly, to methods and apparatus for spread spectrum signal processing using post despreading interpolation.

### BACKGROUND OF THE INVENTION

Spread spectrum modulation techniques increase the bandwidth of a signal by using a code sequence which is known by both the transmitter and the receiver. In direct sequence spread spectrum systems, the information signal is directly modulated by the code sequence, which is referred to as a spreading code or pseudo random code. Code division multiple access (CDMA) is a direct sequence spread spectrum technology for sharing resources in a cellular telephone system. CDMA allows multiple mobile units to communicate with a base station using the same frequency channel at the same time.

As mentioned above, the baseband information signal in CDMA systems is modulated using a code sequence known as a spreading code. The spreading code is made up of a plurality of code elements known as chips. The chip rate (i.e., the number of chips transferred per second) is typically higher than the symbol rate (i.e., the number of data symbols, made up of one or more data bits, transferred per second) of the baseband information signal. In a typical CDMA system, the chip rate may be 4 to 256 times greater than the symbol rate. The result is that the modulated signal is spread over a much wider frequency spectrum than the baseband information signal.

In a CDMA cellular system, each mobile unit uses a different set of spreading codes to communicate with the base station. The spreading codes are selected to have low cross correlation with each other. The base station can identify each transmitting mobile unit based on the spreading code used in the transmission. Similarly, the mobile station may identify and communicate with a base station based on a spreading code for that base station.

CDMA communication systems offer many advantages over narrow band systems. For example, multipath signals can cause interference in a narrow band system. Multipath may be created by reflection of signals from objects in the environment. Because different signal paths have different lengths between the base station and the mobile station, each signal may be received at a different time. Unlike narrow band systems in which such multipath signals may pose a problem known as intersymbol interference, separate multipath signals may be distinguished and separately received in a CDMA system. In addition, signal components received on diverse paths may be aligned in time to produce a stronger signal.

A Rake receiver is employed to process multipath signal components. A Rake receiver typically includes multiple channels, or “fingers”, each of which receives and despreads one of the multipath signal components. A finger compensates for delay via associated synchronization, for example, in a delay lock loop, and correlates a signal received on one of the diverse paths with a spreading code to demodulate the signal and recover the original baseband information signal.

Chip rate processing, such as despreading, is one of the major computation-intensive functions in CDMA baseband signal processing. Oversampling at two times (2×) the chip rate is required for signal recovery. To enhance system performance, a higher sampling rate, usually 8×, is required on chip rate signals. The higher sampling rate increases the required bus bandwidth to transfer the received chip data to the chip rate processor. The oversampling also increases the amount of memory required to store the received chip data. For standards such as UMTS, where it is common to store a full frame of chip data prior to the despread of the data channel, the chip data memory requirement is very large.

Interpolation is a popular method to reduce the bandwidth and memory requirements needed when oversampling is employed. The cost of the interpolation is processing resources. In the conventional approach, interpolation is performed at the chip rate and is performed prior to the execution of any chip data processing functions, such as despread. See, for example, International Application No. WO 02/11387, published Feb. 7, 2002. To avoid increased memory requirements, the interpolated data can be discarded immediately after it is used. However, this further increases the processing requirements, since the same chip data is accessed multiple times for processing different channels or paths (i.e., fingers). Pre-despread interpolation reduces bandwidth requirements at the expense of processing and/or memory.

None of the known CDMA signal processing techniques is entirely satisfactory. Accordingly, there is a need for improved methods and apparatus for signal processing in CDMA systems.

### SUMMARY OF THE INVENTION

According to a first aspect of the invention, a method is provided for processing a spread spectrum baseband signal. The method comprises despreading samples of the baseband signal with two or more instances of a spreading code, the instances of the spreading code successively offset relative to the signal samples, to provide two or more despread results; and interpolating the two or more despread results based on an estimated finger location to provide a symbol estimate.

According to another aspect of the invention, apparatus is provided for processing a spread spectrum baseband signal. The apparatus comprises means for despreading samples of the baseband signal with two or more instances of a spreading code, the instances of the spreading code successively offset relative to the signal samples, to provide two or more despread results, and means for interpolating the two or more despread results based on an estimated finger location to provide a symbol estimate. The apparatus and method may be implemented in a programmed digital signal processor.

### BRIEF DESCRIPTION OF THE DRAWINGS

For a better understanding of the present invention, reference is made to the accompanying drawings, which are incorporated herein by reference and in which:

FIG. 1 is a simplified schematic block diagram of a CDMA baseband signal processor;

FIG. 2 is a schematic block diagram of a Rake receiver used in the chip rate processor of FIG. 1;

FIGS. 3A-3C are schematic representations of a signal processing algorithm in accordance with an embodiment of the invention;

FIG. 4 is a flow diagram of the signal processing algorithm illustrated in FIGS. 3A-3C;

FIG. 5 is a block diagram of a digital signal processor suitable for implementing the algorithm of FIGS. 3A-3C and 4;

FIG. 6 is a block diagram of the computation blocks in the digital signal processor of FIG. 5;

FIG. 7 is a data flow diagram of an embodiment of a despread operation;

FIG. 8 is a data flow diagram of a multiple despread operation in accordance with an embodiment of the invention;

FIGS. 9A and 9B illustrate a register configuration for multiple despreading operations in accordance with an embodiment of the invention;

FIG. 10 is a schematic representation of multiple despread operations that may be performed in a single cycle in accordance with an embodiment of the invention; and

FIG. 11 is a schematic representation of multiple despreading operations with shifted spreading codes.

### DETAILED DESCRIPTION

The present invention is described in the context of transmission of cellular telephone signals. However, many of the techniques described herein, while useful for cellular telephones, may also be useful for other high speed data transmission applications.

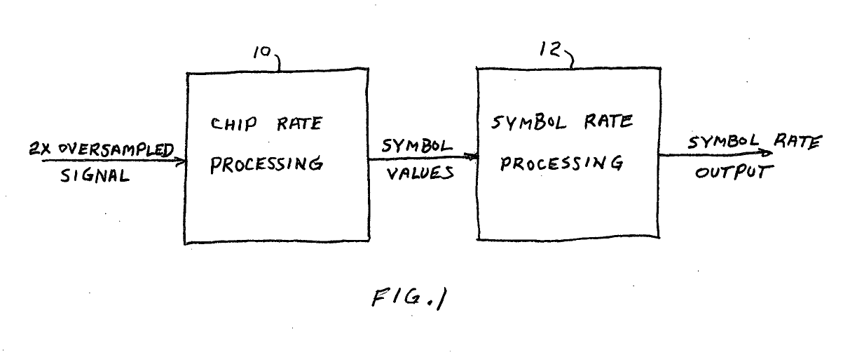

A block diagram of an embodiment of a baseband portion of a wireless telephone base station signal chain is shown in FIG. 1. The signal chain includes chip rate processing 10 and symbol rate processing 12. On the transmit side, symbol rate processing 12 may include a CRC attachment block, a channel coding block, a rate matching block and an interleaving block. On the receive side, the symbol rate processing 12 may include a deinterleaving block, a rate determination block, a channel decoding block and a CRC attachment block. The chip rate processing 10 may include a spreading and modulation block on the transmit side and a rake receiver on the receive side.

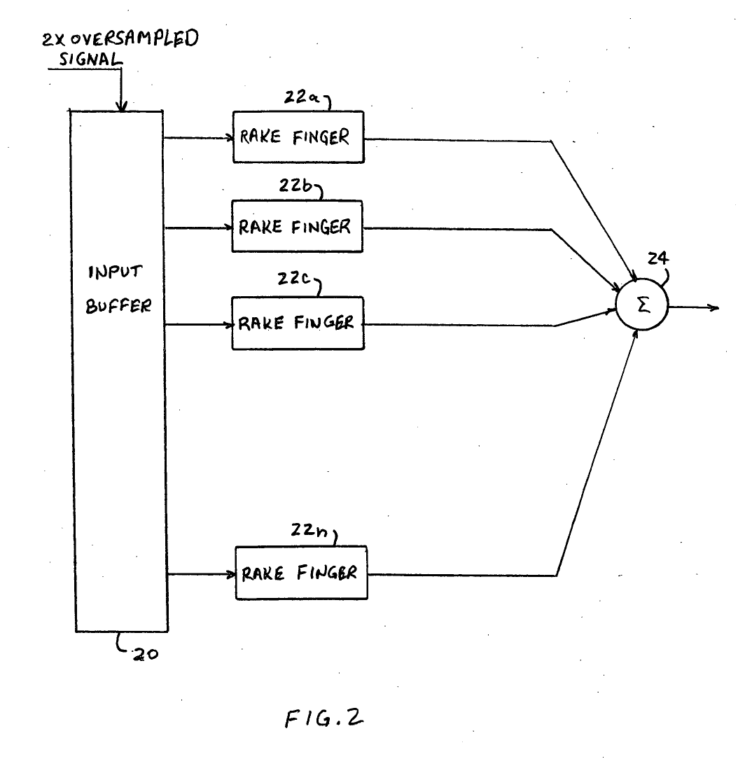

A typical rake receiver architecture is shown in FIG. 2. Rake fingers 22a, 22b, 22c, . . . 22n receive signal components from an input buffer 20. The rake fingers despread different multipath signals which are subsequently combined by a summing unit 24 to produce a stronger signal.

Spreading is a method of altering data whereby a normally narrow band signal is translated into a wide band signal. Spreading a signal over a wide frequency band allows multiple users to transmit and receive on the same frequency band and also allows the signal to be transmitted and received using less power. Spreading is achieved by multiplying the original signal by a spreading code which expands and duplicates the signal. The number of times the signal is duplicated over the wide frequency band is known as the spreading factor. After spreading, the wide band signal is transmitted to the receiver. The signal is despread at the receiver end to recover the original signal. The spreading code used to spread the signal is also used to despread the signal. When multiple signals are combined, each signal requires a spreading code which is orthogonal to every other code, so that the symbols may be retrieved at the receiving end. The signal after spreading is made up of signal portions known as chips.

The original signal is extracted from the received signal by despreading. A despread function is basically a multiply and accumulate function. Received signal samples are multiplied by respective spreading code elements to provide intermediate values, and the intermediate values are accumulated to provide a despread result. Because the complex spreading codes are orthogonal to one another, when the spreading code is multiplied by the received signal, the original symbols which were spread by that spreading code remain and all other symbols cancel.

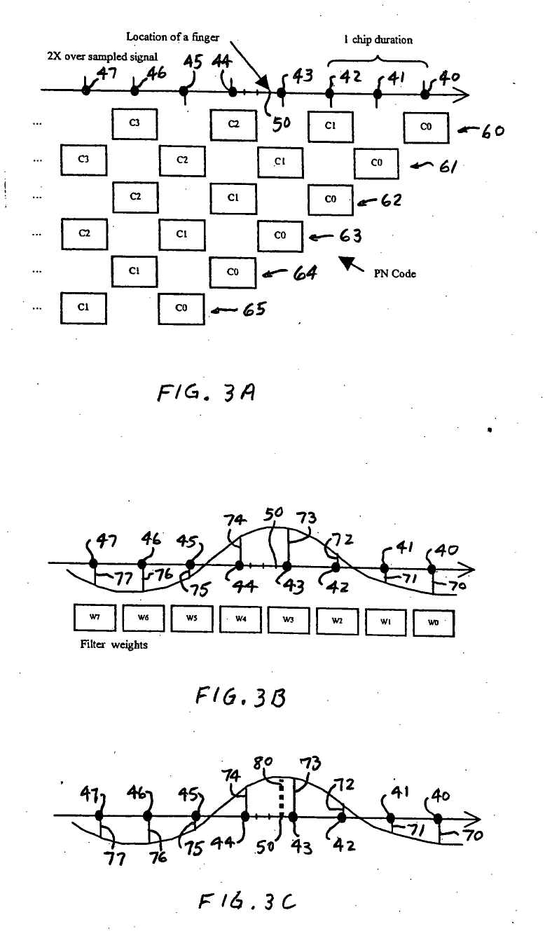

An algorithm in accordance with an embodiment of the invention for processing a spread spectrum baseband signal is shown schematically in FIGS. 3A-3C. In the example of FIGS. 3A-3C, the baseband signal is sampled at two times (2×) the chip rate, thus providing two samples per chip. The 2× sampled baseband signal is represented by samples 40-47 along a time axis at 2× the chip rate. It will be understood that, in practice, a continuous stream of samples is received.

It is assumed that a finger location 50 has been estimated between samples 43 and 44. The finger location 50 is representative of the delay of one signal, or finger, of the multipath signals relative to a reference signal. The estimated finger location 50 may be determined by a path search algorithm, as known in the art, which may be implemented in hardware or software. The path search algorithm is outside the scope of the present invention and is not described further. Path search is described, for example, in International Application No. WO 03/061151, published Jul. 24, 2003.

The spreading code is represented in FIG. 3A by code elements C0, C1, C2, C3, etc. A typical spreading code may have 4 to 256 code elements. Multiple instances 60-65 of the spreading code are illustrated in FIG. 3A. The instances 60-65 of the spreading code are offset, or shifted, relative to the signal samples and relative to each other in increments of one half the chip duration. The code elements are shown in vertical alignment with signal samples with which they are multiplied in the despreading operation. Thus, a first instance 60 of the spreading code has code element C0 aligned with sample 40, code element C1 aligned with sample 42, code element C2 aligned with sample 44 and code element C3 aligned with sample 46. Similarly, a second instance 61 of the spreading code has code element C0 aligned with sample 41; a third instance 62 of the spreading code has code element C0 aligned with sample 42; a fourth instance 63 of the spreading code has code element C0 aligned with sample 43; a fifth instance 64 of the spreading code has code element C0 aligned with sample 44; and a sixth instance 65 of the spreading code has code element C0 aligned with sample 45. It may be observed that each instance of the spreading code includes code elements spaced apart at the chip rate and that successive instances of the spreading code are offset by one half chip with respect to the baseband signal. It will be understood that FIG. 3A is simplified for purposes of illustration and that a practical implementation may include more or fewer code elements in the spreading code and more or fewer instances of the spreading code. Two or more despread results are needed to perform post-despread interpolation as described below.

Each despreading operation illustrated in FIG. 3A involves complex multiplication of each code element by the respective signal samples and accumulation of the intermediate results. Thus, for example, code element C0 is multiplied by sample 40, code element C1 is multiplied by sample 42, code element C2 is multiplied by sample 44, and code element C3 is multiplied by sample 46 to provide intermediate values. The intermediate values are summed to provide a despread result. The despread operation involves complex multiplication and complex addition. The despread operation is repeated for each of the instances of the spreading code to provide a plurality of despread results.

In a typical CDMA system, the chip rate may be on the order of 64 to 128 times the symbol rate. For 2× oversampling, a single symbol may include 128 to 256 samples. The despreading operation is continued until the entire symbol has been despread. In the example of FIG. 3A, despreading is applied to eight samples at a time, and a despread result is produced for each instance of the shifted spreading code. The despread results are accumulated until the entire symbol has been despread. In other embodiments, 2× to 4× oversampling may be utilized.

Referring now to FIG. 3B, the despread results are illustrated as despread results 70-77 at samples 40-47, respectively. According to an embodiment of the invention, the despread results are interpolated to obtain an accurate estimate of the symbol value. Despread results near the estimated finger location 50 are selected for interpolation. In the example of FIG. 3B, eight despread results are selected. In addition, interpolation filter weights, or filter coefficients, are selected. Different sets of filter coefficients, known as polyphase filter coefficients, may be utilized for interpolating the despread results to obtain samples at different times.

In the example of interpolating a 2× oversampled signal to obtain an 8× oversampled signal, three additional samples are required for each sample of the 2× oversampled signal. The three additional samples are equally spaced between two samples of the 2× oversampled signal. A different set of interpolation filter coefficients may be utilized to calculate each of the three additional samples. However, since the finger location 50 has been estimated, the sample value at finger location 50 may be calculated, and the other samples are not needed. Interpolation filter coefficients W0-W7, which correspond to finger location 50, are utilized in the interpolation. Accordingly, the selected despread results 70-77 near finger location 50 and the selected filter coefficients W0-W7 corresponding to finger location 50 are utilized to perform interpolation. The interpolation involves multiplying the despread results 70-77 by respective filter coefficients W0-W7 to obtain eight intermediate values and summing the intermediate values to provide an interpolation result 80. As shown in FIG. 3C, the interpolation result 80 represents the sample value at finger location 50 and thus provides an estimate of the symbol value. It may be noted that interpolation is performed after despreading in the algorithm of FIGS. 3A-3C. It may be shown mathematically that pre-despreading interpolation and post-despreading interpolation generate the same result.

In the example of FIGS. 3A-3C, an interpolation filter having eight coefficients, or weights, is utilized. It will be understood that different interpolation filter configurations may be utilized. In other embodiments, an interpolation filer having four coefficients may be utilized, and a minimum interpolation filter has two coefficients. The interpolation accuracy may be increased by using a larger number of interpolation coefficients, at the expense of increased processing.

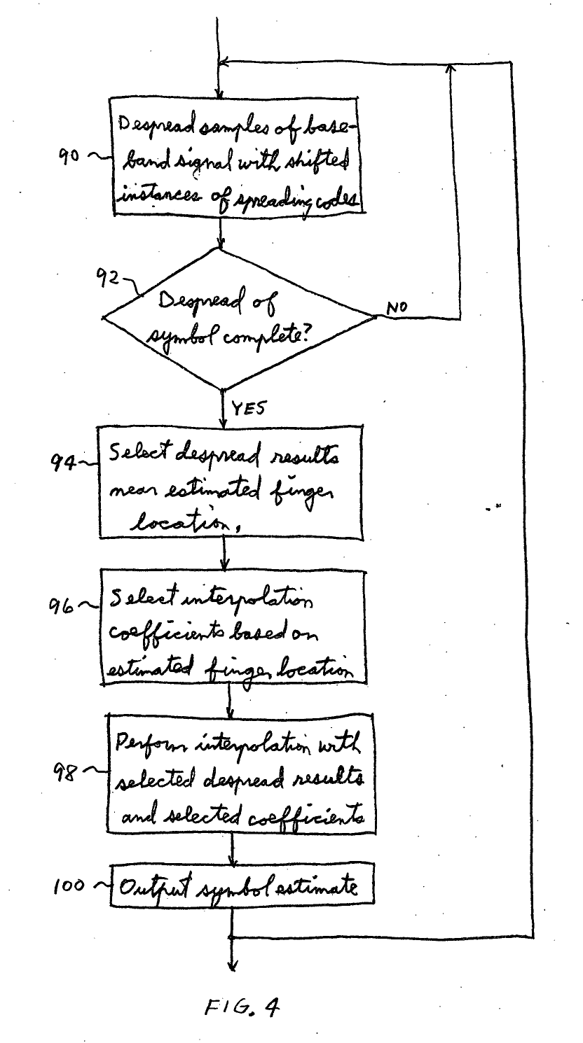

The algorithm for processing a spread spectrum baseband signal according to an embodiment of the invention is illustrated in the flow chart of FIG. 4. In step 90, samples of the baseband signal are despread with two or more offset instances of the spreading code to obtain despread results, as shown in FIG. 3A and described above. The number of samples of the baseband signal and the number of offset instances of the spreading code may be selected according to the application. In step 92, a determination is made whether despreading of a symbol is complete. As noted above, a symbol may include 64 or 128 chips and therefore may include 128 or 256 signal samples at a 2× sampling rate. If despreading of the symbol is not complete, the process returns to step 90 and performs additional despreading operations.

When despreading of the symbol is complete, despread results near the estimated finger location are selected in step 94. The number of despread results depends on the number of coefficients in the interpolation filter being utilized. In step 96, interpolation filter coefficients are selected based on the estimated finger location. As discussed above, the interpolation filter coefficients are selected from a set of polyphase filter coefficients to obtain an estimate of the symbol value at the estimated finger location. In step 98, the interpolation is performed using the selected despread results and the selected interpolation filter coefficients. The interpolation involves multiplying the selected despread results by the respective interpolation filter coefficients to obtain intermediate values and summing the intermediate values to provide an interpolation result. The interpolation result is output in step 100 as an estimated symbol value. The process then returns to step 90 for a processing of the next symbol.

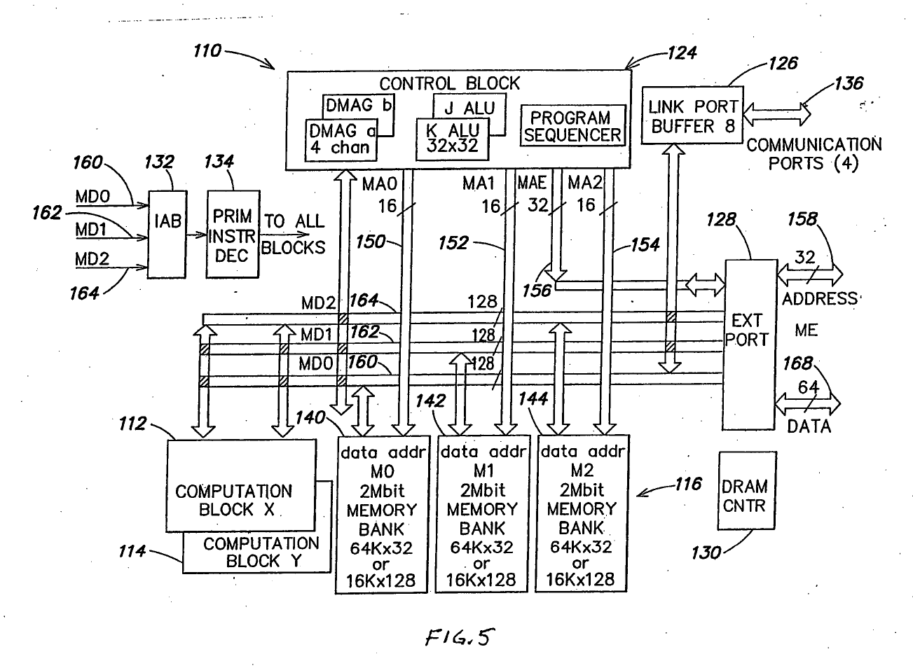

The algorithm for processing a spread spectrum baseband signal according to embodiments of the invention may efficiently be performed by a programmed digital signal processor. A block diagram of an example of digital signal processor (DSP) 110 suitable for implementing features of the present invention is shown in FIG. 5. Principal components of the DSP 110 include computation blocks 112 and 114, a memory 116, a control block 124, link port buffers 126, an external port 128, a DRAM controller 130, an instruction alignment buffer (IAB) 132, and a primary instruction decoder 134. The computation blocks 112 and 114, the instruction alignment buffer 132, the primary instruction decoder and the control block 124 constitute a core processor which performs the main computation and data processing functions of the DSP 110. The external port 128 controls external communication via an external address bus 158 and an external data bus 168. The link port buffers 126 control external communication via communication ports 136. The DSP is preferably configured as a single monolithic integrated circuit.

The memory 116 may include three independent, large capacity memory banks 140, 142 and 144. In a preferred embodiment, each of the memory banks 140, 142 and 144 has a capacity of 64K words of 32 bits each. Each of the memory banks 140, 142 and 144 preferably has a 128-bit data bus. Up to four consecutive aligned data words of 32 bits each can be transferred to or from each memory bank in a single clock cycle.

The elements of DSP 110 are interconnected by buses for efficient, high speed operation. Address buses 150, 152 and 154 interconnect the banks of memory 116 and control block 124. An external address bus 156 interconnects external port 128 and control block 124. Data buses 160, 162 and 164 interconnect the banks of memory 116, computation blocks 112 and 114, control block 124, link port buffers 126, IAB 132 and external port 128.

In a typical operating mode, program instructions are stored in one of the memory banks, and operands are stored in the other two memory banks. Thus, at least one instruction and two operands can be provided to the computation blocks 112 and 114 in a single clock cycle. Each of the memory banks 140, 142 and 144 may be configured to permit reading and writing of multiple data words in a single clock cycle. The simultaneous transfer of multiple data words from each memory bank in a single clock cycle is accomplished without requiring an instruction cache or a data cache.

Multiple data words can be accessed in each memory bank in a single clock cycle. Specifically, data can be accessed as single, dual, or quad words of 32 bits each. Using quad word transfers, four instructions and eight operands, each of 32 bits, can be supplied to the computation blocks 112 and 114 in a single clock cycle. The number of data words transferred and the computation block or blocks which the data words are transferred are selected by control bits in the instruction. The single, dual or quad data words can be transferred to computation block 112, to computation block 114, or to both. Dual and quad data word accesses improve the performance of the DSP 110 by allowing several operands to be transferred to the computation blocks 112 and 114 in a single clock cycle. The ability to access multiple instructions in each clock cycle allows multiple operations to be executed in each clock cycle, thereby improving performance.

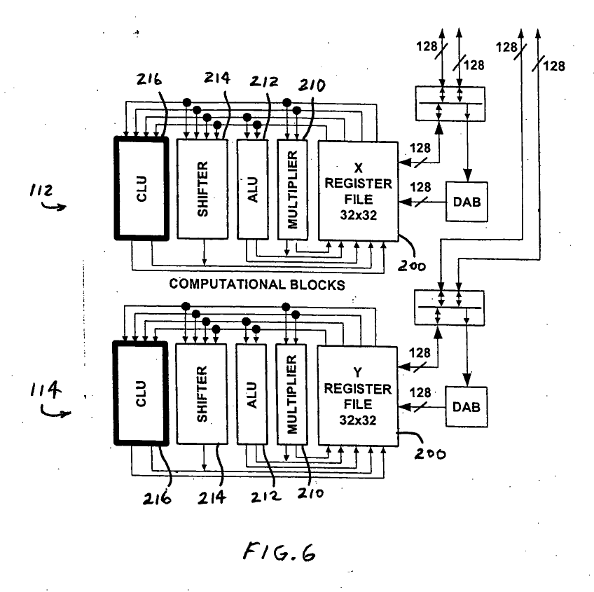

A block diagram of an embodiment of computation blocks 112 and 114 is shown in FIG. 6. In each computation block, a multiple port register file 200 provides temporary storage of operands and results. In a preferred embodiment, each register file 200 has a capacity of 32 words of 32 bits each, organized as eight rows of 128 bits. Each register file 200 is connected through a multiplexer and latch to each of the data buses 160, 162 and 164 (FIG. 5). When operands are fetched from memory 116, two of the three data buses are selected, and the operands on the selected buses are supplied to the register files 200.

Each computation block shown in FIG. 6 includes a multiplier/accumulator (MAC) 210, an arithmetic logic unit (ALU) 212, a shifter 214 and a communication logic unit (CLU) 216. The multiplier/accumulator 210, the ALU 212, the shifter 214, and the CLU 216 in each of the computation blocks 112 and 114 are capable of simultaneous execution of instructions to the extent that sufficient instructions and operands can be supplied to the computation blocks 112 and 114. In each computation block, operands are supplied from register file 200 to multiplier/accumulator 210, ALU 212, shifter 214, and CLU 216 on operand buses 220. Results from the multiplier/accumulator 210, the ALU 212, the shifter 214, and the CLU 216 are returned to register file 200 on result buses 222. Each computation block preferably has a pipelined architecture for improved performance. The CLU 216 in each computation block includes registers for temporary storage of data and control values, and circuitry for executing specified instructions. The CLU may perform despreading, as described below. A suitable DSP 110 is the TigerSharc ADSP-TS201 digital signal processor, available from Analog Devices, Inc.

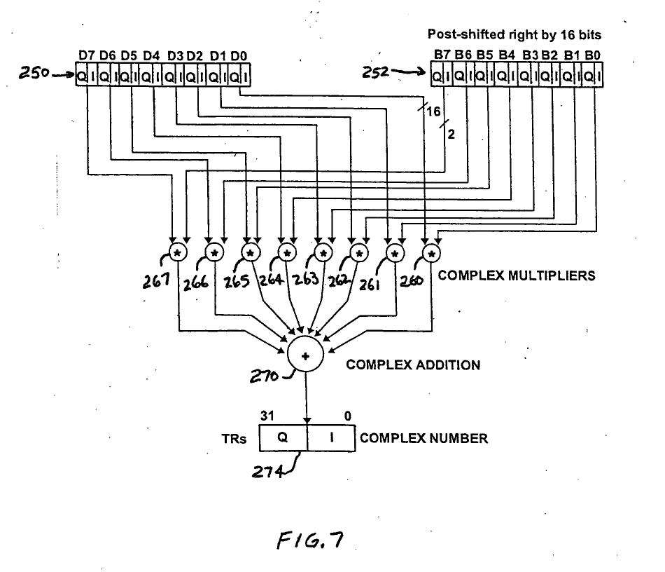

A data flow diagram that illustrates a despread unit is shown in FIG. 7. In some embodiments, the DSP shown in FIGS. 5 and 6 and described above may perform one or more despread operations in response to a single despread instruction. The values of eight 16-bit chips, or samples, each sample including eight real bits and eight imaginary bits, are held in a sample register 250 (128 bits total), and the values of 32 two-bit spreading code elements, each code element including one real bit and one imaginary bit, are held in a code register 252. Eight code elements (16 bits) of code register 252 are used during execution of the despread instruction. After the despread instruction is executed, the code register 252 is logically shifted 16 bits to the right to load new spreading code elements into an active portion of the register. As shown is FIG. 7, each code element in code register 252 is multiplied by a corresponding sample stored in data register 250 using complex multipliers 260-267. The results of these multiplies are added by a complex summing unit 270 and stored in a result register 274. The despread result has a 16-bit real part and a 16-bit imaginary part. Each despread operation shown in FIG. 3A and described above corresponds to the despread operation shown in FIG. 7. In particular, the despread operation corresponds to the despreading of one instance of the spreading code with the samples of the baseband signal. Despreading in digital signal processors is further described in International Application No. WO 03/015305, published Feb.20, 2003.

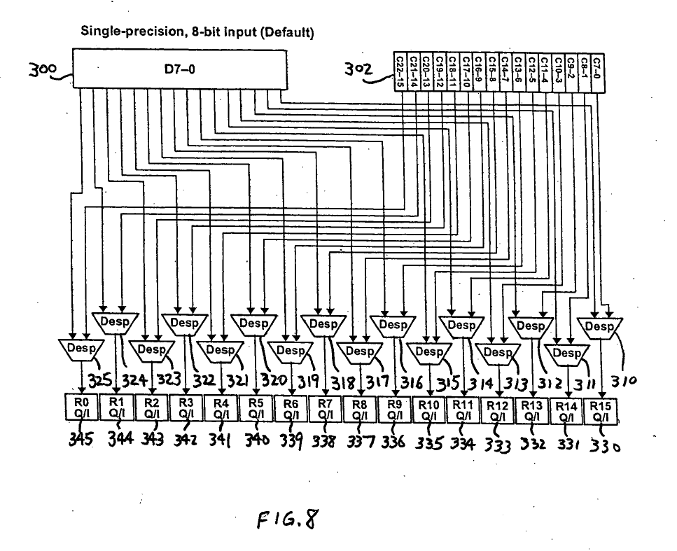

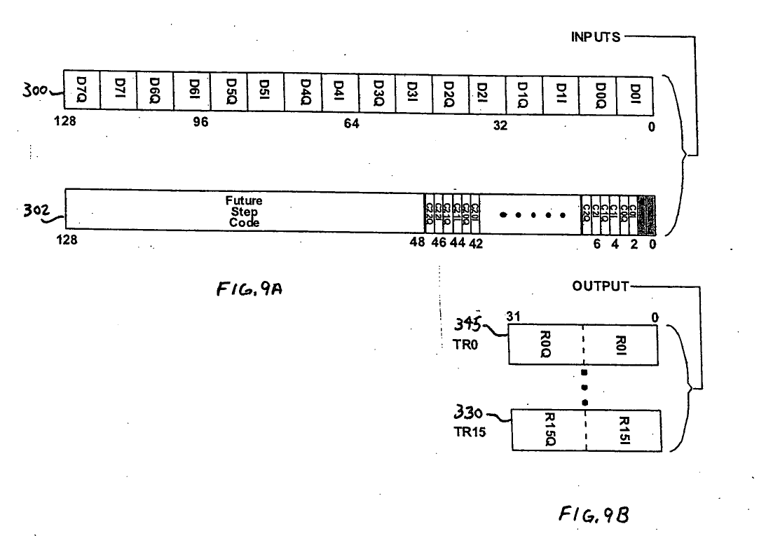

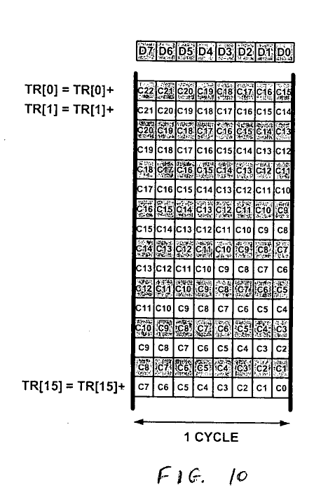

FIG. 8 is a data flow diagram that illustrates an embodiment of multiple despreading operations in a single cycle. FIGS. 9A and 9B illustrate examples of register contents during multiple despreading operations. FIG. 10 is a table that represents the multiple despreading operations performed in a single cycle as illustrated in the data flow diagram of FIG. 8. The multiple despreading operations may be performed using an XCORR instruction that is available in the DSP shown in FIGS. 4 and 5 and described above.

In the embodiment of FIGS. 8-10, a data register 300 holds data samples and a code register 302 holds spreading code elements. In this embodiment, data register 300 holds eight data samples D0-D7 of 16 bits each. Each sample includes an eight-bit imaginary part DxQ and an eight-bit real part DxI. Code register 302 may include 23 code elements of two bits each. Each code element includes a one-bit imaginary part CxQ and a one-bit real part CxI. As shown in FIG. 8, the data samples and the code elements are applied to despread units 310-325. Each of the despread units 310-325 may correspond to the despread unit shown in FIG. 7 and described above. The multiple despreading operations shown in FIGS. 8-10 may be performed in CLU 216 of computation blocks 112 and/or 114. The results of despread units 310-325 are placed in result registers 330-345, respectively. Each result has a 16-bit real part and a 16-bit imaginary part.

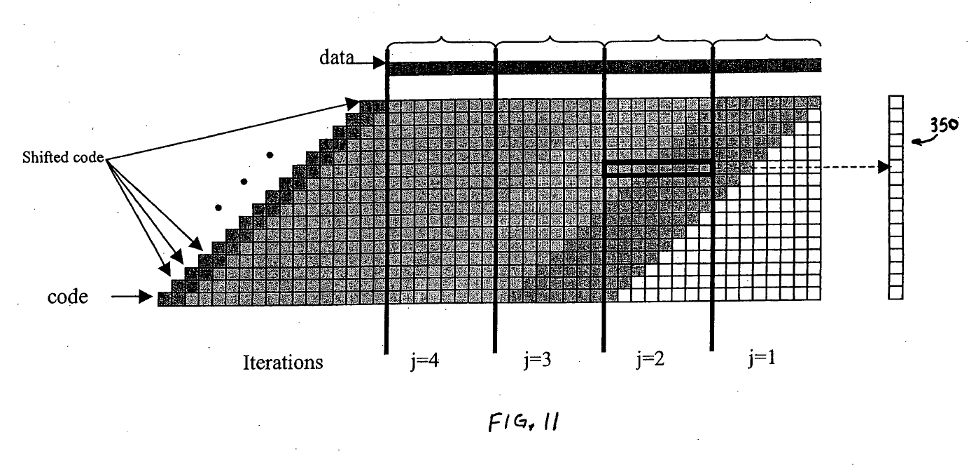

Referring to FIG. 10, the despreading operations in a single cycle are shown schematically. Each row of the table represents an instance of the spreading code that is used for despreading data samples D0-D7. Thus, beginning at the bottom of the table, a first despreading operation is performed with code elements C0-C7 and data samples D0-D7; a second despreading operation is performed with code elements C1-C8 and data samples D0-D7; a third despreading operation is performed with code elements C2-C9 and data samples D0-D7, etc. It may be noted that in each despreading operation the code elements are offset by one chip, or data sample, with respect to the data samples. FIG. 10 illustrates the despreading operations performed during one cycle. This operation is repeated as shown in FIG. 11 on multiple sets of data samples (j=1, j=2, j=3, etc.) until despreading of a symbol is completed. The result is a set of despread results 350 which are interpolated as described above to provide a symbol estimate.

Because a mobile handset moves, the location of a detected finger also moves. A delay lock loop algorithm may be used in CDMA systems to track the drifting of fingers. In a delay lock loop, despreading is performed at an early location, the on-time or estimated location and a late location. The distances between the early, the on-time and the late locations are algorithm dependent. Usually, the distances are one half chip or less. By comparing the despreading results of the early, on-time and late locations the drifting direction of the finger is determined and the on-time location is adjusted. If the on-time location is correct, the early and late despread results are approximately equal. If the early despread result is greater than the late despread result, or vice versa, the on-time location is shifted and the measurement is repeated. The delay lock loop algorithm results in tracking of a moving finger.

The delay lock loop algorithm requires computation of despread results at three locations, the early, on-time and late locations. The post-despread interpolation described above can be utilized to despread closely located fingers. That is, despreading is performed on a set of offsets around the three locations of interest. Then, three different sets of polyphase filter coefficients are applied to obtain the interpolated despreading results for the three locations. The complexity of despreading three locations is significantly reduced because the despread results have already been computed during the post-despread interpolation.

A key operation in post-despread interpolation is a set of despreading operations on multiple offsets around the estimated finger location. This operation includes intensive complex correlations between signals and spreading codes. The XCORRS instruction of the DSP described above is suitable to efficiently perform the computation. In one execution of the XCORRS instruction, the spreading code is automatically shifted sixteen times, one chip each shift. The despreading operation is performed on each shifted spreading code. Consequently, the output of the instruction is the despreading results over sixteen offsets. The computation blocks 112 and 114 of the DSP 110 can simultaneously generate despreading results over 32 offsets. In one cycle, the two computation blocks can perform a total 256 complex correlations between signal samples and spreading codes. The DSP can preserve the resolution of the despreading result with 16-bit real and 16-bit imaginary complex numbers. Furthermore, the computation power of eight 16-bit multiply-accumulates per cycle can perform the post-despread polyphase filtering with acceptable speed. It should also be noted that the polyphase filtering can be performed in parallel with the despreading operation due to the superscalar architecture of the DSP described above, further increasing the speed of filtering.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

1. A method for processing a spread spectrum baseband signal, comprising:
despreading samples of the baseband signal with two or more instances of a spreading code, the instances of the spreading code successively offset relative to the signal samples, to provide two or more despread results; and
interpolating the two or more despread results based on an estimated finger location to provide a symbol estimate.

2. A method as defined in claim 1, wherein the samples of the baseband signal are oversampled at two to four times a chip rate.

3. A method as defined in claim 2, wherein the step of interpolating the two or more despread results produces an effective sampling of the baseband signal at eight times the chip rate.

4. A method as defined in claim 1, wherein interpolating the two or more despread results includes selecting the despread results around the estimated finger location.

5. A method as defined in claim 4, wherein interpolating the two or more despread results comprises selecting interpolation coefficients based on the estimated finger location.

6. A method as defined in claim 5, wherein the step of interpolating the two or more despread results comprises multiplying the selected despread results by respective selected interpolation coefficients to provide intermediate values and summing the intermediate values to provide the symbol estimate.

7. A method as defined in claim 1, wherein the step of interpolating the two or more despread results is repeated at a symbol rate.

8. A method as defined in claim 1, wherein despreading samples of the baseband signal comprises multiplying the samples by respective code elements to provide intermediate values and accumulating the intermediate values to provide a despread result.

9. A method as defined in claim 1, wherein successive instances of the spreading code are offset by one half chip relative to the signal samples.

10. A method as defined in claim 1, wherein the steps of despreading samples of the baseband signal and interpolating the two or more despread results are performed by a programmable digital signal processor.

11. A method as defined in claim 10, wherein the step of despreading samples of the baseband signal comprises performing a plurality of despreading operations simultaneously.

12. A method as defined in claim 1, wherein interpolating the two or more despread results comprises:
interpolating the two or more despread results using interpolation coefficients corresponding to the estimated finger location,
interpolating the two or more despread results using interpolation coefficients corresponding to a time earlier than the estimated finger location, and
interpolating the two or more despread results using interpolation coefficients corresponding to a time later than the estimated finger location.

13. Apparatus for processing a spread spectrum baseband signal, comprising:
means for despreading samples of the baseband signal with two or more instances of a spreading code, the instances of the spreading code successively offset relative to the signal samples, to provide two or more despread results; and
means for interpolating the two or more despread results based on an estimated finger location to provide a symbol estimate.

14. Apparatus as defined in claim 13, wherein the samples of the baseband signal are oversampled at two to four times a chip rate.

15. Apparatus as defined in claim 14, wherein the means for interpolating the two or more despread results performs an effective sampling of the baseband signal at eight times the chip rate.

16. Apparatus as defined in claim 13, wherein the means for interpolating the two or more despread results includes means for selecting the despread results around the estimated finger location.

17. Apparatus as defined in claim 16, wherein the means for interpolating the two or more despread results comprises means for selecting interpolation coefficients based on the estimated finger location.

18. Apparatus as defined in claim 17, wherein the means for interpolating the two or more despread results comprises means for multiplying the selected despread results by respective selected interpolation coefficients to provide intermediate values and means for summing the intermediate values to provide the symbol estimate.

19. Apparatus as defined in claim 13, wherein the means for interpolating the two or more despread results operates at a symbol rate.

20. Apparatus as defined in claim 13, wherein the means for despreading samples of the baseband signal comprises means for multiplying the samples by respective code elements to provide intermediate values and means for accumulating the intermediate values to provide a despread result.

21. Apparatus as defined in claim 13, wherein successive instances of the spreading code are offset by one half chip relative to the signal samples.

22. Apparatus as defined in claim 13, wherein the means for despreading and the means for interpolating are implemented by a programmable digital signal processor.

23. Apparatus as defined in claim 22, wherein the means for despreading samples of the baseband signal comprises means for performing a plurality of despreading operations simultaneously.

24. Apparatus for processing a spread spectrum baseband signal, comprising:
a digital signal processor including a memory for holding instructions and data, program sequencer for controlling execution of an instruction sequence and at least one computation block for executing the instruction sequence, said computation block including means for despreading samples of the baseband signal with two or more instances of a spreading code, the instances of the spreading code successively offset relative to the signal samples, to provide two or more despread results, and means for interpolating the two or more despread results based on an estimated finger location to provide a symbol estimate.
